(19) United States
(12) Patent Application Publication
(10) Pub. No.: US 2025/0368521 A1
(43) Pub. Date: Dec. 4, 2025

(54) RECOVERY OF MULTI-METAL-OXIDES FROM BLACK MASS

(71) Applicant: ACE GREEN RECYCLING INC., Houston, TX (US)

(72) Inventors: Avijit Gautam, Noida (IN); Vijay Raman Chaudhari, Jalgaon (IN); Kavaiya Ashish Rajeshkumar, Vadodara (IN); Greeshma Suresh Babu, Palakkad (IN); Paramjeet Singh Bakshi, Bareilly (IN); Sundaram Samaddar, Ghaziabad (IN); Sanchari Basak, Kolkata (IN)

(73) Assignee: ACE GREEN RECYCLING INC., Houston, TX (US)

(21) Appl. No.: 18/763,011

(22) Filed: Jul. 3, 2024

Related U.S. Application Data
(60) Provisional application No. 63/652,489, filed on May 28, 2024.

(51) Int. Cl. C01D 15/08; C01G 53/00; C22B 7/00; C22B 26/12; H01M 10/54

(52) U.S. Cl. CPC C01D 15/08; C01G 53/40; C22B 7/007; C22B 26/12; H01M 10/54

(57) ABSTRACT

Disclosed are approaches for recycling LIBs where lithium is recovered before the other node metals in order to increase the amount of lithium recovered. For such approaches, the other node metals need not be further refined or recovered and, despite the small loss of these other node metals as impurities in the first-recovered lithium, the available alternative dispositions for these other node metals—such as in the form of multi-metal-oxides (MMO)—can render the recovery of lithium before the other node metals to be advantageous. Several such approaches may feature nitration, roasting, lithium trapping, and/or other innovative features to facilitate greater and purer recoveries of the target LIB components.

### CROSS-REFERENCE TO RELATED APPLICATION(S)

This application claims benefit of and priority to, and incorporates by reference herein in its entirety, U.S. Provisional Application No. 63/652,489, filed May 28, 2024, titled “SYSTEMS AND METHODS FOR LITHIUM-FIRST BATTERY RECYCLING” (Attorney Docket No. AGR2400US0P).

### BACKGROUND

Lithium-ion batteries (LIBs) are widely used in many different applications, from power-production storage and electric vehicles, to backup power supplies and batteries found in a variety of personal portable electronic devices. Generally, LIB batteries comprise both node materials (that is, the materials found in anodes and cathodes of batteries) and non-node materials (battery materials not part of the anode or cathode). As such, the node materials in LIBs generally comprise graphite, lithium, and other node metals, the latter being specific to the metallic composition of the cathode in the LIB.

Although LIBs may have different “chemistries” (that is, differing cathode and anode material compositions) the two most common types of LIBs are nickel-manganese- cobalt (NMC) batteries and lithium-iron-phosphate (LFP) batteries. As their names suggest, the node materials of NMC LIBs include graphite, lithium, nickel, manganese, and cobalt (and may also include iron, silicon, and/or carbon)—specifically, a graphite anode and a cathode comprising lithium, nickel, manganese, and cobalt (e.g., a blend of LiNiO2 plus LiMnO2 plus LiCoO2 collectively represented by the chemical formula LiNixMnyCozO2 where x+y+z equals 1) while the node materials of LFP LIBs include graphite, lithium, iron, and phosphate (and may also include manganese)—specifically, a graphite anode and a cathode comprising lithium, iron, and phosphate (e.g., LiFePO4).

Today the majority of LIBs are still mostly constructed from new materials stemming from the mining and refining of new lithium and other “node metals” (the specific metals used in the anode and cathode of the LIBs). Similarly, the majority of LIBs—and especially small-form-factor LIBs used in personal devices and the like—are disposed of in landfills when they reach the end of their useful life. However, there is a growing need for recycling LIBs to both recapture the valuable components therein and decrease the need for new materials, as well as to achieve environmental advantage from reducing waste and avoiding landfills plus the benefits of decreased mining and refining of new materials.

For a variety of reasons, LIB recycling has largely focused on maximizing the recovery of graphite or the recovery of the other node metals—for example, the nickel, manganese, and cobalt of NMC LIBs, and the iron and phosphate of LFP LIBs—which decreases the amount of lithium that can be recovered because of the portion of lithium, sometimes as much as 30% of the total lithium, that is lost as impurities in the other node metals when recovered first.

### SUMMARY

Various implementations disclosed herein are directed to systems, methods, and other utilizations for recycling LIBs where lithium is recovered before the other node metals in order to increase the amount of lithium recovered. For such approaches, the other node metals need not be further refined or recovered and, despite the small loss of these other node metals as impurities in the first-recovered lithium, the available alternative dispositions for these other node metals—such as in the form of multi-metal-oxides (MMO)—can render the recovery of lithium before the other node metals to be advantageous. Several such approaches may feature nitration, roasting, lithium trapping, and/or other innovative features to greater and purer recoveries of the target LIB components. As such, the various implementations disclosed herein are beneficial for and directly related to one or more methodologies for “lithium-first” recycling of LIBs.

More specifically, various implementations disclosed herein are directed to methods for recovering components from lithium-ion batteries (LIBs) comprising: removing graphite from black mass produced from the LIBs before recovering lithium and one or more other node metals present in the black mass; transforming the one or more other node metals present in the black mass into LF-metal-oxides; removing lithium from the black mass before recovering the one or more other node metals present in the black mass; and recovering the one or more other node metals. Several such implementations may further comprise features whereby: removing graphite from black mass produced from the LIBs before recovering lithium and one or more other node metals present in the black mass further comprises removing graphite from black mass produced from the LIBs before recovering lithium and all other node metals present in the black mass; transforming the one or more other node metals present in the black mass into LF-metal-oxides further comprises transforming two or more other node metals present in the black mass into LF-metal-oxides; transforming the two or more other node metals present in the black mass into LF-metal-oxides further comprises transforming all other node metals present in the black mass into LF-metal-oxides; wherein removing lithium from the black mass before recovering the one or more other node metals present in the black mass further comprises removing lithium from the black mass before recovering all of the other node metals present in the black mass; recovering the one or more other node metals further comprises recovering the one or more other node metals as an individual LF-metal-oxide (IMO) if comprising only one metal and as multi-metal-oxides (MMO) if comprising more than one metal; the acid leaching is performed at ambient conditions without application of external heat or pressure; removing lithium from the black mass further comprises combining the black mass with water to form a mixture comprising a lithium solution and the one or more other node metals as insoluble components of said mixture; the black mass is ground into fine particles before being combined with water, and wherein said water is pure water; the combination of black mass and water is maintained at a temperature of between 70 degrees C. and 99 degrees C. for no less than two hours (or, alternatively, no less than thirty minutes) and no more than five hours; the combination of black mass and water is maintained at a temperature of between 80 degrees C. and 90 degrees C. for no less than three hours (or, alternatively, no less than thirty minutes) and no more than four hours; removing lithium from the black mass before recovering the one or more other node metals present in the black mass further comprises combining the black mass with water to form a mixture comprising a lithium solution and the one or more other node metals as insoluble components of said mixture, and physically separating the lithium solution from the mixture; removing graphite from black mass produced from the LIBs before recovering lithium and one or more other node metals present in the black mass further comprises treating the black mass with nitric acid (HNO3) to dissolve the lithium and the one or more other node metals to form a solution from which the insoluble graphite is then physically removed; transforming the one or more other node metals present in the black mass into LF-metal-oxides further comprises treating the black mass with nitric acid (HNO3), and applying heat to the black mass for a period of time to form LF-metal-oxides; the applied heat is between 150 degrees C. and 350 degrees C. and the period of time is between 9 hours and 15 hours (or, alternatively, no more than 24 hours); and/or the applied heat is between 290 degrees C. and 310 degrees C. and the period of time is between 11 hours and 13 hours. Certain such implementations may also further comprise acid leaching the resultant IMO or MMO.

Furthermore, various implementations disclosed herein also may be directed to systems comprising one or more subsystems capable of: removing graphite from black mass produced from the LIBs before recovering lithium and one or more other node metals present in the black mass; transforming the one or more other node metals present in the black mass into LF-metal-oxides; removing lithium from the black mass before recovering the one or more other node metals present in the black mass; and recovering the one or more other node metals as an individual LF-metal-oxide (IMO) if comprising only one metal and as multi-metal-oxides (MMO) if comprising more than one metal. Several such implementations may further comprise features whereby transforming the one or more other node metals present in the black mass into LF-metal-oxides further comprises treating the black mass with nitric acid (HNO3), and applying heat to the black mass to facilitate formation of LF-metal-oxides for each of the one or more other node metals present in the black mass.

In addition, various implementations disclosed herein may be directed to computer-readable media comprising computer-readable instructions for causing an automated apparatus to: remove graphite from black mass produced from the LIBs before recovering lithium and one or more other node metals present in the black mass; transform the one or more other node metals present in the black mass into LF-metal-oxides; remove lithium from the black mass before recovering the one or more other node metals present in the black mass; and recover the one or more other node metals as an individual LF-metal-oxide (IMO) if comprising only one metal and as multi-metal-oxides (MMO) if comprising more than one metal.

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a process flow diagram illustrating an exemplary approach for “lithium first” LIB recycling representative of the various implementations disclosed herein;

FIG. 2 is a modified block diagram illustrating an exemplary system for “lithium-first” LIB recycling representative of the various implementations disclosed herein;

FIG. 3 is a modified block diagram illustrating an exemplary system for creating black mass by removing non-node materials in a manner representative of the various implementations disclosed herein;

FIG. 4 is a process flow diagram illustrating an exemplary approach for creating black mass by removing non-node materials in a manner representative of the various implementations disclosed herein;

FIG. 5 is a process flow diagram illustrating an exemplary approach for targeted recovery of graphite from black mass representative of the various implementations disclosed herein;

FIG. 6 is a modified block diagram illustrating an exemplary system for targeted recovery of graphite from black mass representative of the various implementations disclosed herein;

FIG. 7 is a process flow diagram illustrating an exemplary approach for roasting a black mass nitratenated slurry representative of the various implementations disclosed herein;

FIG. 8 is a modified block diagram illustrating an exemplary system for roasting a black mass nitratenated slurry representative of the various implementations disclosed herein;

FIG. 9 is a process flow diagram illustrating an exemplary approach for regenerating nitric acid (HNO3) from NOX created during roasting of black mass representative of the various implementations disclosed herein;

FIG. 10 is a modified block diagram illustrating an exemplary system for regenerating nitric acid (HNO3) from NOX created during roasting of black mass representative of the various implementations disclosed herein;

FIG. 11 is a process flow diagram illustrating an exemplary approach for the recovery lithium from black mass before recovery of individual metal-oxides representative of the various implementations disclosed herein;

FIG. 12 is a modified block diagram illustrating an exemplary system for the recovery lithium from black mass before recovery of individual metal-oxides representative of the various implementations disclosed herein;

FIG. 13 is a process flow diagram illustrating an exemplary approach for the recovery of trapped lithium from “wet” black mass representative of various implementations disclosed herein;

FIG. 14 is a modified block diagram illustrating an exemplary system for the recovery of trapped lithium from “wet” black mass representative of various implementations disclosed herein;

FIG. 15 is a process flow diagram illustrating an exemplary approach for the recovery of individual metal-oxides (IMOs) after extraction of lithium from black mass in a manner representative of various implementations disclosed herein;

FIG. 16 is a modified block diagram illustrating an exemplary system for the recovery of individual metal-oxides (IMOs) after extraction of lithium from black mass in a manner representative of various implementations disclosed herein;

FIG. 17 is a block diagram of an example computing environment that may be used in conjunction with any of the various implementations and aspects herein disclosed.

### DETAILED DESCRIPTION

When recycling LIBs, the extraction of specific components from the resulting black mass is somewhat imperfect in that any particular component extracted from the mix of components found in the black mass may inherently include small amounts of the other materials present in the black mass. For example, if the cobalt metal component is extracted first from the black mass of an NMC LIB, some small portion of nickel, manganese, and lithium may still adhere to (and/or otherwise be removed with) the cobalt when separated and removed from the black mass. Conversely, some small amount of cobalt may also remain behind in the black mass, although this amount of cobalt left behind in the black mass may be comparatively less than the residual amounts of the other components that are removed with the cobalt and which are impurities in the cobalt so removed.

As such, the first component removed may have the highest recovery percentage of the target metal but may also be the most impure because of the residual amounts of the other components that have adhered thereto, while the last component removed from the black mass—or what is left at the end when all other components have been removed—may have the lowest recovery percentage (due to the material lost during preceding extraction of the other components), but this last component may also be of the highest relative purity compared to the earlier-recovered components.

Because the first component recovered from LIB black mass will generally have the relatively highest percentage of recovered material from the total amount of that particular material found in the black mass—by virtue of being first removed—almost none of such first component will be lost during the individual recovery of other components (for which recovery is subsequent and has not yet occurred). Thereafter, when the second component is recovered, it may be comparatively less complete (i.e., lower relative percentage of recovered material from that available in the black mass) because of the lost portion of the second component inadvertently removed during recovery of the first component (and which is an impurity in the removed first component). This trend continues for each subsequently removed component (third, fourth, fifth, etc.) until what remains is the last component (or combination of components) which may have the relatively most material lost during recovery of the other preceding components, but which also may be relatively purer than the earlier- removed components.

Today almost all known methodologies for LIB recycling focus on the extraction of metals from black mass before the recovery of lithium, which results in relatively pure lithium but the relatively lowest yield because of amounts lost with the removal of the other metals (as impurities in such removed metals). This is partly due to a number of different factors including, for example, what may be the relatively higher value of the other component metals compared to lithium—and thus an intentional desire for higher recovery percentages and lesser loss of these components—but the ubiquitousness of this approach also reflects the lack of known or utilized alternative processes for recovering lithium first. Consequently, a certain amount of lithium is lost during metal extraction, such as in the form of lithium residue adhering to each of the other target metals when extracted from the black mass (e.g., cobalt, nickel, and manganese for an NMC LIB). As a result, a relatively larger amount of lithium may be lost during LIB recycling due to the other component metals being extracted first and taking with each of them a small amount of lithium as an inherent impurity, thereby diminishing the overall amount of lithium left to be recovered at the end of the process.

However, there are several distinct advantages to recovering lithium before recovering the other metal components in an LIB. First, by removing the lithium at the outset, before removing the other metals, the resulting purity of the other recovered metals may be higher and thus provide a greater value versus a larger amount of less pure metals. Second, given the inherent detriments and risks that unrecovered lithium poses to the environment, achieving a higher percentage recovery of lithium is more environmentally sound and may be or may become necessary to meet ever-tightening environmental regulations. Third, when lithium is recovered first, the resulting metals (e.g., cobalt, manganese, and nickel) in their unseparated and unrefined forms (e.g., as an alloy thereof) have a market value and a market demand that may not require further processing and indirectly provide even greater economic benefit (which may not be the case for such a mix of metals when lithium is still present therein). Lastly, the extraction of lithium before the other target metals may also enable the utilization of new and better, more efficient, lower cost, and/or more environmentally friendly processes than those utilized in current existing lithium-last (or lithium-later) recovery processes for LIB recycling.

Accordingly, disclosed herein are various implementations featuring processes and/or subprocesses related to new and innovative “lithium-first” recovery in LIB recycling. Stated differently, disclosed herein are various implementations generally directed to the recycling of LIBs where lithium is recovered before the other node metals in order to increase the amount of lithium recovered while recognizing that the other node metals need not be further refined or recovered, even at the cost of small loss thereof (i.e., losses as impurities in the first-recovered lithium), because of other alternative dispositions for the other node metals in the form of multi-metal-oxides (MMO) that may result from removing the lithium first. As such, the various implementations disclosed herein are beneficial for and directly related to one or more methodologies for “lithium-first” recycling of LIBs.

Although certain instances of these implementations may be described for specific recycling of one type of LIB (e.g., NMC LIBs comprising nickel, manganese, and cobalt and/or LFP LIBs comprising iron and phosphate), such descriptions are also explicitly intended to apply to all types of LIBs as well as other lithium-based batteries, other batteries using alternatives to lithium, or other recyclables to which such processes could be applied, and nothing herein is intended to limit such processes to any single LIB type but, instead, should be broadly interpreted for all such possible implementations as will be well-understood and readily-appreciated by skilled artisans.

Furthermore, an understanding of various concepts is helpful toward a broader and more complete understanding of the various implementations disclosed herein, and skilled artisans will readily appreciate the implications these various concepts have on the breadth and depth of the various implementations herein disclosed. And while the several and various implementations disclosed herein may be described as specifically pertaining to or directed to use in recycling of lithium-ion batteries (LIBs) and/or recovery of node metals therefrom, such implementations may be equally applied to the recovery of other metals and/or other metal sources. Accordingly, nothing herein is intended to limit the various implementations solely to LIB recycling or node metal recovery but, instead, the various implementations disclosed herein may be applied to a variety of different electrolytic processes and electrolysis-based operations, and thus the disclosures made herein should be read as broadly as possible as applied to a variety of different metals being extracted or recovered from a variety of potentially different sources.

Moreover, certain terms used herein may also be used interchangeably with other terms used herein and such terms should be given the broadest interpretation possible unless explicitly noted otherwise. For example, as used herein the terms electrolysis, electrowinning, and electrorefining should be treated as interchangeable terms such that where one term is used the other terms are also implied, and thus any use of the term electrolysis should be understood to also include electrowinning and electrorefining except where explicitly differentiated. Moreover, as used herein the term “electrolytic processes” (and variations thereof) is explicitly intended to include and encompass electrolysis, electrowinning, and electrorefining, each individually and collectively.

Additionally, as will be readily appreciated and well-understood by skilled artisans, substances that might typically be represented by their chemical compositions using subscripted numbers—such as gaseous oxygen (O₂), water (H₂O), and so forth—may instead be represented herein with regular numbers in lieu of subscripted numbers (i.e., as O2 for gaseous oxygen, H20 for water, and so forth) as the same and equivalent as if subscripted numbers were utilized, and no distinction should be made as to the use of regular numbers versus the use of subscripted numbers anywhere herein.

As used herein (both heretofore and hereafter), the term “near-pure” shall mean a purity comparable to within 90% of the average purity obtainable by traditional smelting processes. Likewise, the term “pure” shall mean a purity that is equal to or exceeds the typical purity level obtainable by traditional processes known and appreciated by skilled artisans, and the term “perfect purity” shall mean a purity that is 99.000% comprised of the elemental metal without regard to natural surface oxidation or hydroxidation. Accordingly, for all implementations disclosed herein for obtaining “near-pure” metal, such disclosures should be deemed to also disclose alternative implementations for obtaining “pure” and “perfectly pure” metals as well. Also as used herein, the term “recovery” and other equivalent terms (e.g., purification, derivation, etc.) shall refer to the obtaining of a purer metal (e.g., elemental lead) from a less pure form of said metal (e.g., lead oxides), metal compounds, or metal mixes, by any physical, chemical, electrolytical, or other purification processes.

With regard to the various components making up LIBs, the anodes and cathodes may be collectively referred to herein simply as “nodes,” and terms characterized by the term “node” such as “node metals” or “node materials” refer to both anode and cathode materials. Likewise, the term “non-node” and variations thereof refer to battery components other than those constituting the anodes and cathodes. Similarly, the term “black mass” shall refer to the mix of node materials resulting from battery breaking after the removal of non-node materials (which, prior to such removal, may be more generally referred to simply as the “mass”) and, for convenience, black mass may continue to refer to such material throughout removal of components therefrom. For example, black mass from which graphite is removed may still be referred to as black mass until only a single component or equivalent remains, and that this minor imprecision is not in any way intended to limit the disclosure herein. Similarly, when an element is removed from the black mass, it is presumed that some portion of the other components may also be inadvertently removed (as an impurity to that which is removed) and that some portion of the component removed is also inadvertently left behind (as an impurity to that which is left behind), but these residual amounts (as impurities) are ignored for purposes of describing the various implementations herein. For example, when a component (such as graphite) is described as being removed (or any similar term) from a source (e.g., the black mass), it should be understood as meaning “substantially removed” in an amount greater than 50% (and often much greater) of that component present in the source from which it is being removed with the remainder being inadvertently (or inevitably) left behind as a residual impurity, and vice versa with regard to impurities inadvertently (or inevitably) removed with the target component.

Based on these understandings and parameters for proper interpretation of the disclosures made herein, skilled artisans will well-understand and readily-appreciate the breath and scope of the various implementations herein disclosed.

### Lithium-First Battery Recycling

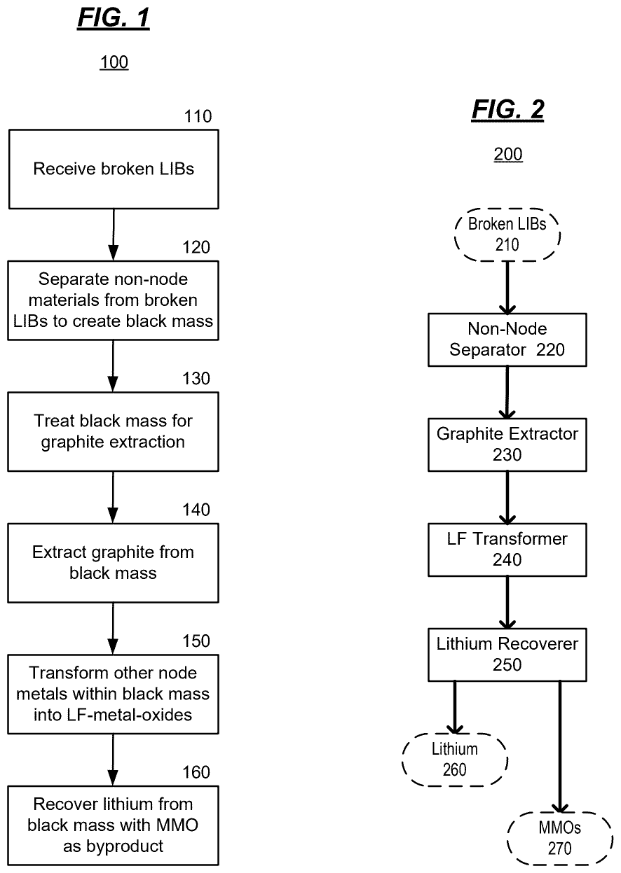

FIG. 1 is a process flow diagram 100 illustrating an exemplary approach for “lithium-first” LIB recycling representative of the various implementations disclosed herein. In FIG. 1, at 110 broken LIBs are received and, at 120, the non-node materials (e.g., aluminum, copper, polypropylene, steel, and so forth in any of several different forms) may be separated therefrom to create black mass comprising the node materials (e.g., graphite, lithium, and other node metals in any of several different forms). At 130 the black mass may then be chemically treated (e.g., treated with nitric acid, that is, “nitratenated” or “nitrated,” as described in greater detail later herein) to facilitate, at 140, the extraction of the graphite from the black mass. At 150 the resultant black mass (now graphite free) may be further processed to transform the other node metals into lithium-free metal oxides (referred to herein as “LF-metal-oxides”), effectively separating the lithium atomically from the other node metals and metal compounds within the black mass. Then at 160 the lithium is recovered from the black mass with the latter comprising multi-metal-oxides (MMO) as a “byproduct” (i.e., as a separate resultant product), said MMO comprising two or more metal oxides that could be further refined into individual metal-oxides (IMO)—such as through leaching or other known processes—or repurposed or sold asis without further refining.

FIG. 2 is a modified block diagram 200 illustrating an exemplary system for “lithium-first” LIB recycling representative of the various implementations disclosed herein. As shown in FIG. 2, broken LIBs 210 are inputs received by the non-node separator 220 for separating the non-node metals from the broken LIBs to create black mass. The non-node separator 220 is operably coupled to a graphite extractor 230 for extraction of the graphite from the black mass. The graphite extractor 230 is operably coupled to the LF Transformer 240 for transforming the other node metals in the black mass into lithium-free (“LF”) metal oxides, that is, LF-metal-oxides. The LF Transformer 240 is operably coupled to the lithium recoverer 250 which then recovers and outputs the lithium 260 as well as the MMO 270 as a byproduct for further refining into the individual metal oxides (or pure metals), or alternatively disposes of the MMOs in some other fashion (such as sale for use by a third party interested in the MMO as-is).

Additional details are provided in the various subsections below, the totality of which may be collectively summarized in the remaining paragraphs of this present subsection as follows:

Disclosed herein are various implementations directed to methods for recycling lithium-ion batteries (LIBs), the method comprising: separating non-node materials from broken LIBs to create black mass comprising graphite, lithium, and other node metals; extracting graphite from the black mass; transforming the other node metals within the black mass into LF-metal-oxides; and/or recovering the lithium from the black mass, with the remainder comprising multi-metal-oxides (MMO) as a byproduct.

Several such implementations may further comprise features whereby: the non-node materials comprise at least one from among the group comprising polypropylene, aluminum, copper, and steel; the separating of the non-node materials to produce the black mass further comprises at least one processing element from among the group of processing elements comprising zig-zag separating (ZZSing) the mass into a first submass comprising magnetic non-node metals and a second submass comprising magnetic node metals, magnetically removing the magnetic non-node metals from the first submass, linear-vibratory screening (LVSing) the mass, said mass constituting the first submass and the second submass, and vibratory-classifying screening (VCSing) the mass to filter out remaining non-node materials from the mass; extracting graphite from the black mass further comprises treating the black mass with nitric acid (HNO3) to dissolve the lithium and one or more other node metals to form a solution, the solution and the graphite together forming a solid-liquid mixture, and separating the graphite from the solution by physically removing the graphite from the mixture; the black mass is treated with nitric acid (HNO3) without external heating and for a period of time no less than four hours and no more than 24 hours; transforming the other node metals within the black mass into LF-metal-oxides comprises roasting the solution to form lithium compounds and multi-metal-oxides (MMOs) from the other node metals; and/or the roasting is performed at one temperature-plus-time setting from among the group of temperature-plus-time settings comprising at temperatures between 150 degrees C. and 350 degrees C. for a duration of no less than 9 hours and no more than 24 hours, at temperatures between 290 degrees C. and 310 degrees C. for a duration of no less than 11 hours and no more than 25 hours, and at a temperature of substantially 300 degrees C. for a duration of less than 26 hours; the renewed nitric acid (HNO3) is used in a subsequent treatment of a subsequent black mass; recovering the lithium from the black mass comprises combining the black mass with water to form a mixture comprising a lithium solution and one or more water-insoluble components, physically separating the lithium solution from the one or more water-insoluble components of the black mass, said components comprising the multi-metal-oxides (MMO); the combination of black mass and water is maintained at one temperature-plus-time setting from among the group of temperature-plus-time settings comprising at a temperature of between 70 degrees C. and 99 degrees C. for no less than two hours (or, alternatively, no less than thirty minutes) and no more than five hours, and/or at a temperature of between 80 degrees C. and 90 degrees C. for no less than three hours (or, alternatively, no less than thirty minutes) and no more than four hours; the black mass is ground into fine particles before being combined with water, and said water is pure water; physically separating the lithium solution from the one or more water-insoluble components further comprises saturating the black mass with alcohol to facilitate physical separation of the water and the lithium trapped by the MMO; the alcohol comprises at least one alcohol subgroup from among the group of alcohol subgroups comprising an alcoholic mixture comprising a monohydric alcohol, an alcoholic mixture comprising ethanol (C2H5OH), an alcoholic mixture comprising only ethanol (C2H5OH) and water, 90% pure ethanol (C2H5OH), 95% pure ethanol (C2H5OH), and 99% pure ethanol (C2H5OH); and/or the treating is maintained at one temperature range from among the group of temperature ranges comprising at a temperature of between 80 degrees C. and 99 degrees C., and at a temperature within three degrees of 90 degrees C.

Certain such implementations may also further comprise: capturing the gaseous nitrogen oxides (NOX) that are produced as a byproduct of the nitric acid (HNO3) treatment of the black mass, regenerating the NOX back into renewed nitric acid (HNO3); treating the lithium solution with sodium carbonate (Na2CO3) to precipitate the lithium from the solution as lithium carbonate (Li2CO3) and a sodium solution as a byproduct, and removing the lithium carbonate (Li2CO3) from the resultant solution; extracting the lithium in pure form from the lithium carbonate (Li2CO3); and/or metal-processing the MMO to derive the one or more other node metals each in a pure form.

Furthermore, various implementations disclosed herein also may be directed to systems for recycling lithium-ion batteries (LIBs), the system comprising one or more subsystems capable of: separating non-node materials from broken LIBs to create black mass comprising graphite, lithium, and other node metals; extracting graphite from the black mass; transforming the other node metals within the black mass into LF-metal-oxides; and recovering the lithium from the black mass, with the remainder comprising multi-metal-oxides (MMO) as a byproduct.

In addition, various implementations disclosed herein may be directed to computer-readable media comprising computer-readable instructions for causing an automated apparatus to: separate non-node materials from broken LIBs to create black mass comprising graphite, lithium, and other node metals; extract graphite from the black mass; transform the other node metals within the black mass into LF-metal-oxides; and recover the lithium from the black mass, with the remainder comprising multi-metal-oxides (MMO) as a byproduct.

Several of these summarized features are described in more detail in the subsections that follow.

### Separating Black Mass from Broken Batteries

Removing non-node materials from broken LIBs—such as aluminum, copper, steel, and polypropylene, for example—is generally the first step in generating black mass, a very beneficial step for lithium-first recovery.

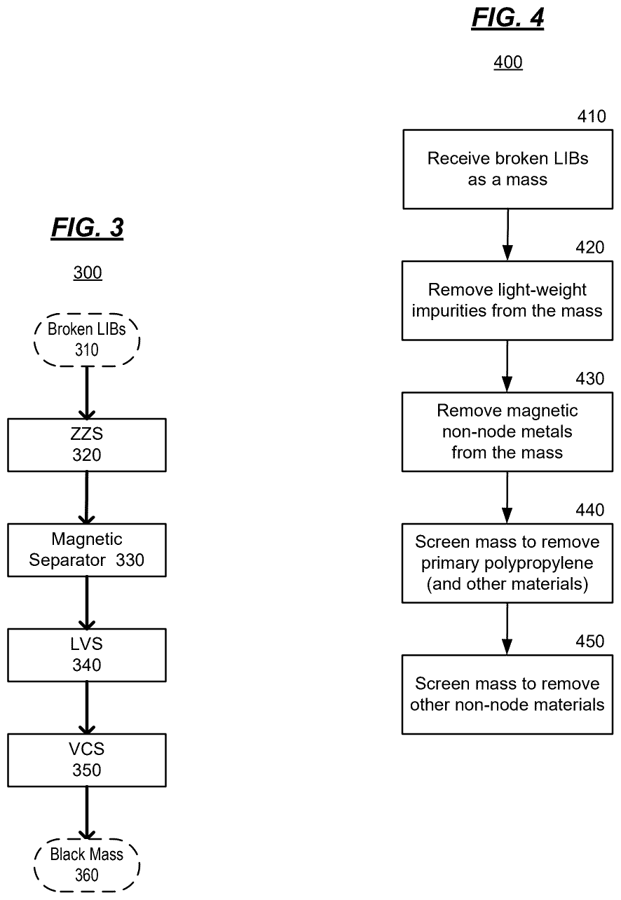

FIG. 3 is a modified block diagram 300 illustrating an exemplary system for creating black mass by removing non-node materials in a manner representative of the various implementations disclosed herein. As shown in FIG. 3, the system 300—which corresponds to the non-node separator 220 of FIG. 2—may comprise a zig-zag separator (17S) 320 for removing relatively light-weight impurities (which may include at least some polypropylene) from the mass of broken LIBs 310. As known and appreciated by skilled artisans, the zig-zag separator separates different materials by specific gravity, shape, and size utilizing an enclosed gravity-based structure with an opposing air flow such that lighter materials may be extracted from higher collection points (i.e., the top) and heavier materials may be extracted from lower collection points (i.e., the bottom) thus enabling the targeted separation of specific materials one from another. The 17S 320 may then be operably coupled to a magnetic separator 330 for removing, using any of several techniques known and appreciated by skilled artisans, the magnetic non-node metals (e.g., steel) from the mass, albeit without removing the bulk of magnetic node metals in the mass, to form a resultant second mass (now having no non-node magnetic metals). The magnetic separator 330 then may be operably coupled to a linear-vibratory screener (LVS) 340 for screening out primary polypropylene components from the second mass to form a resultant third mass. The LVS 340 then may be operably coupled to a vibratory-classifying screener (VCS) 350 for filtering out remaining non-node materials from the third mass to produce the black mass. The LVS 340 and/or the VCS 350 may further incorporate or utilize a hammer/crusher (not shown) to reduce the third mass into finer material after being screened by the LVS 340 but before being filtered by the VCS 350.

FIG. 4 is a process flow diagram 400 illustrating an exemplary approach for creating black mass by removing non-node materials in a manner representative of the various implementations disclosed herein. In FIG. 4, at 410 the broken LIBs are received and, at 420, light-weight impurities (which may include at least some polypropylene) are removed from the mass by, for example, zig-zag separating the mass to remove the relatively light-weight impurities. At 430 magnetic non-node metals are then removed from the mass using any of several techniques known and appreciated by skilled artisans to do so. At 440, polypropylene (herein referred to as “primary polypropylene”) may be screened from the mass which, for certain implementations, may be performed by linear-vibratory screening (LVSing). At 450 the mass may be further screened to filter out of the mass the other non-node materials such as aluminum, copper, and secondary polypropylene (that was not screened as part of the primary polypropylene) and which, for certain implementations, may be performed by vibratory-classifying screening (VCSing). Both LVSing and VCSing are screening processes known and appreciated by skilled artisans. Each of the materials removed from the mass may be further processed and reclaimed for subsequent use, and the resultant mass after these processes constitutes black mass.

The system and method described above may also comprise various additional beneficial features such as, for example, a crusher for crushing the mass into finer particles prior to filtering (as mentioned above). Additional processing of the removed materials may also be undertaken, such as a dealuminator utilized for de-aluminumizing the mass to recover the aluminum and/or a flotation separator may be variously utilized for recovering copper, removing the tertiary polypropylene, or both. Regardless, the black mass produced by the systems and methods is intended to comprise a mix of lithium, nickel, manganese, and cobalt for NMC LIBs or lithium, iron, and phosphate for LFP LIBs.

Accordingly, disclosed herein are various implementations directed to systems for extracting black mass from a first mass of broken lithium-ion batteries (LIBs), the system comprising: a zig-zag separator (17S) for separating the first mass into a first submass comprising magnetic non-node metals and a second submass comprising magnetic node metals; a magnetic separator for removing the magnetic non-node metals from the first submass, the first submass and the second submass constituting a second mass; a linear-vibratory screener (LVS) for screening out primary polypropylene components from the second mass to form a resultant third mass; and/or vibratory-classifying screener (VCS) for filtering out remaining non-node materials from the third mass to produce the black mass. Certain such implementations may further comprise: a recombiner for recombining the first submass and the second submass to form the second mass prior to the LVS screening or prior to the VCS screening; and/or a crusher for crushing the third mass into finer particles prior to the filtering.

Several such implementations may further comprise features whereby: the remaining non-node materials comprise a mix of one or more of copper, aluminum, and secondary polypropylene; the mix further comprises residual black mass adhering to one or more components of said mix; the system further comprises a dealuminator for de-aluminumizing the mix to recover the aluminum and form a resultant second mix, and/or a flotation separator for recovering the copper, removing the tertiary polypropylene, or both from the second mix to derive from the second mix a secondary black mass combinable with the produced black mass; the black mass produced by the system comprises lithium, nickel, manganese, and cobalt; the black mass produced by the system comprises lithium, iron, and phosphate; the magnetic non-node metals of the first submass comprise at least one of iron or steel from the broken LIBs; and/or the magnetic node metals of the second submass comprise at least one of cobalt or nickel from the broken LIBs.

Furthermore, various implementations disclosed herein also may be directed to methods for extracting black mass from a mass of broken lithium-ion batteries (LIBs), the method comprising: zig-zag separating (ZZSing) the mass into a first submass comprising magnetic non-node metals and a second submass comprising magnetic node metals; magnetically removing the magnetic non-node metals from the first submass; linear-vibratory screening (LVSing) primary polypropylene components from the mass, said mass constituting the first submass and the second submass; and vibratory-classifying screening (VCSing) the mass to filter out remaining non-node materials from the mass to produce the black mass. Certain such implementations may also further comprise: recombining the first submass and the second submass to reform the mass prior to the LVSing or prior to the VCSing; and/or comprising crushing the mass into finer particles prior to the VCSing. Several such implementations may further comprise features whereby: the remaining non-node materials comprise a mix of one or more of copper, aluminum, and secondary polypropylene; the mix further comprises residual black mass adhering to one or more components of said mix; the method further comprises de-aluminumizing the mix to recover the aluminum and form the mix, and recovering the copper, removing the tertiary polypropylene, or both from the mix to derive secondary black mass combinable with the produced black mass; the produced black mass comprises lithium, nickel, manganese, and cobalt (plus graphite); the produced black mass comprises lithium, iron, and phosphate (plus graphite); the magnetic non-node metals of the first submass comprise at least one of iron or steel from the broken LIBs; and/or the magnetic node metals of the second submass comprise at least one of cobalt or nickel from the broken LIBs.

In addition, various implementations disclosed herein may be directed to computer-readable media comprising computer-readable instructions for causing an automated apparatus to perform extraction of black mass from a mass of broken lithium-ion batteries (LIBs) by: separating the mass into a first submass comprising magnetic non-node metals and a second submass comprising magnetic node metals; removing the magnetic non-node metals from the first submass; screening primary polypropylene components from the mass, said mass constituting the first submass and the second submass; and filtering out a mix of remaining non-node materials from the mass to produce the black mass. Certain such implementations may further comprise additional computer-readable instructions for: de-aluminumizing the mix to recover the aluminum and form the mix, and recovering the copper, removing the tertiary polypropylene, or both from the mix to derive secondary black mass combinable with the produced black mass.

### Targeted Graphite Removal

After non-node materials are removed from the broken LIBs, the resultant black mass has an abundance of graphite, the removal of which may facilitate efficient and cost-effective subsequent elements in “lithium-first” processing (corresponding to 130 and 140 of FIG. 1).

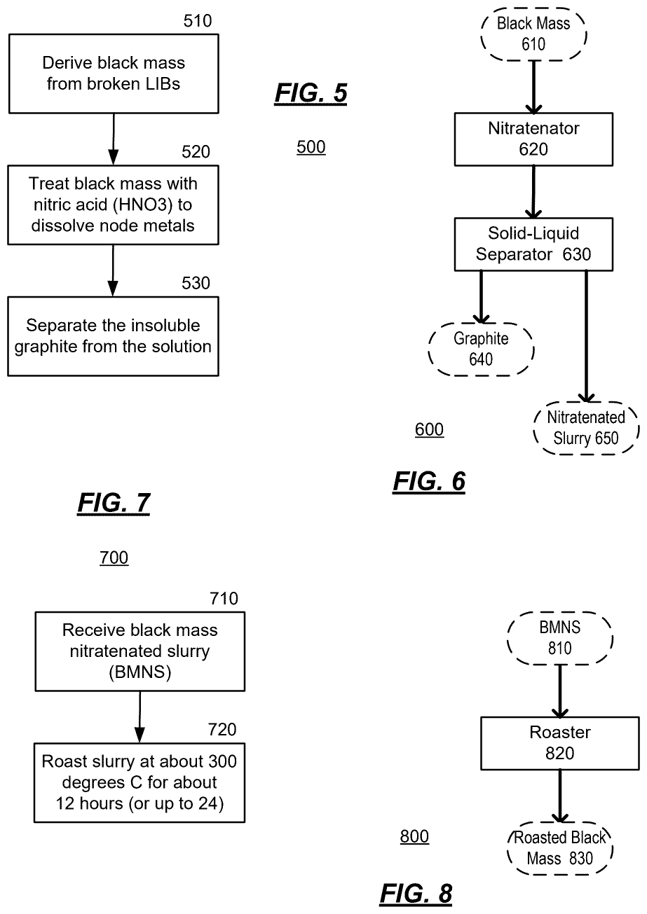

FIG. 5 is a process flow diagram 500 illustrating an exemplary approach for targeted recovery of graphite from black mass representative of the various implementations disclosed herein. In FIG. 5, and after black mass is derived from the broken LIBs at 510—wherein the removed non-node components may include iron, steel, aluminum, copper, and/or polypropylene, among other materials—at 520 the black mass is treated with nitric acid (HNO3) to dissolve the lithium and other node metals to form a solution (i.e., become liquid) whereas the graphite is insoluble in nitric acid (HNO3) and remains solid, or at least does so at relatively low temperatures. This, in turn, enables the solid graphite to be separated from the liquid solution at 530, the latter now comprising the remaining black mass as a nitratenated slurry.

As previously discussed, initially deriving the black mass comprises removing non-node components from the mass of broken LIBs such that the black mass substantially comprises graphite, lithium, and the other node metals (albeit with residual amounts of non-node materials as inherent impurities that are here acknowledged but can be otherwise ignored). Regardless, one advantage to this approach is that the black mass may be treated with the nitric acid (HNO3) without the need for any external heating (although some degree of natural heating may result from the chemical reactions resulting from the combination). It may also be preferable for the nitric acid (HNO3) treatment to last for a period of time no less than four hours and no more than 24 hours—such as for roughly (or exactly) five hours or six hours—before removing the graphite to maximize both the amount of graphite recovered and minimize the loss of other materials from the black mass as impurities in the removed graphite. Once the graphite is separated (and dried if necessary), the separated graphite may be utilized in the production of new anodes or for any other related or unrelated use. Regardless, this foregoing process may be applicable to black mass derived from nickel-manganese-cobalt (NMC) batteries, lithium-iron-phosphate (LFP) batteries, or both.

FIG. 6 is a modified block diagram 600 illustrating an exemplary system for targeted recovery of graphite from black mass representative of the various implementations disclosed herein. As illustrated in FIG. 6, the system may comprise a nitratenator 620 for receiving the black mass and for treating it with nitric acid (HNO3) to dissolve the lithium and the one or more other node metals to form a solution while the graphite (again, insoluble in nitric acid (HNO3)) remains solid. The nitratenator 620 then may be operably coupled to a solid-liquid separator 630 for physically separating the graphite 640 from the solution 650, said solution 650 being a nitratenated (or nitrated) slurry of the black mass nitrate solution.

Accordingly, disclosed herein are various implementations directed to methods for performing targeted recovery of graphite from a mass of broken lithium-ion batteries (LIBs) comprising: deriving black mass from the mass of broken LIBs; treating the black mass with nitric acid (HNO3) to dissolve the lithium and one or more other node metals to form a solution; and separating the graphite, which is insoluble, from the solution. Certain such implementations may also further comprise drying the graphite after the separating. Several such implementations may further comprise features whereby: the deriving of the black mass comprises removing non-node components from the mass of broken LIBs to produce black mass; the non-node components comprise graphite, lithium, and one or more other node metals; the black mass is treated with nitric acid (HNO3) without external heating; the black mass is treated with nitric acid (HNO3) for a period of time no less than four hours and no more than 24 hours; the separated graphite is utilized in the production of one or more new anodes; the mass of broken LIBs comprise broken nickel-manganese-cobalt (NMC) batteries; the mass of broken LIBs comprise broken lithium-iron-phosphate (LFP) batteries; and/or the removed non-node components include at least one from among the group comprising aluminum, copper, and polypropylene.

Furthermore, various implementations disclosed herein also may be directed to systems comprising one or more subsystems for performing targeted recovery of graphite from a mass of broken lithium-ion batteries (LIBs), said system capable of: deriving black mass from the mass of broken LIBs; treating the black mass with nitric acid (HNO3) to dissolve the lithium and the one or more other node metals to form a solution; and separating the graphite, which is insoluble, from the solution. Certain such implementations may also further comprise drying the graphite after the separating. Several such implementations may further comprise features whereby: the deriving of the black mass comprises removing non-node components from the mass of broken LIBs to produce black mass, and wherein the non-node components comprise graphite, lithium, and one or more other node metals; the black mass is treated with nitric acid (HNO3) without external heating, and wherein the black mass is treated with nitric acid (HNO3) for a period of time no less than four hours and no more than 24 hours; and/or the mass of broken LIBs comprise broken nickel-manganese-cobalt (NMC) batteries, broken lithium-iron-phosphate (LFP) batteries, or both.

In addition, various implementations disclosed herein may be directed to computer-readable media comprising computer-readable instructions for causing an automated apparatus to perform targeted recovery of graphite from a mass of broken lithium-ion batteries (LIBs) by: deriving black mass from the mass of broken LIBs; treating the black mass with nitric acid (HNO3) to dissolve the lithium and the one or more other node metals to form a solution; and separating the graphite, which is insoluble, from the solution. Several such implementations may further comprise additional computer-readable instructions whereby: the deriving of the black mass comprises removing non-node components from the mass of broken LIBs to produce black mass, the non-node components comprising graphite, lithium, and one or more other node metals; treating the black mass with nitric acid (HNO3) without external heating; treating the black mass with nitric acid (HNO3) for a period of time no less than four hours and no more than 24 hours; and/or drying the graphite after the separating.

### Variable Temperature Processing (“Roasting”)

After the graphite is removed from the black mass nitrate solution in the form of a nitratenated (or nitrated) slurry, this solution can then be roasted at specific temperatures for specific durations to facilitate chemical reactions within the slurry to enhance atomic separation of the lithium from the other node metals. More specifically, the slurry may be roasted at a temperature of up to or about 300 degrees C. for twelve (12) hours (or, alternatively, up to 24 hours) to achieve beneficial effects, although other temperatures and times may also yield other intended results based on specific needs, component elements in the slurry, purity of the slurry, volume of the slurry, and a host of other factors.

FIG. 7 is a process flow diagram 700 illustrating an exemplary approach for roasting a black mass nitratenated slurry (BMNS) representative of the various implementations disclosed herein. In FIG. 7, after treating the black mass with nitric acid (HNO3) to dissolve lithium and the other node metals to form a solution, and after separating the graphite from the solution, at 710 the BMNS is received and, at 720, is roasted for approximately twelve (12) hours (or, alternatively, up to 24 hours) at a temperature of up to or about 300 degrees C. to facilitate chemical reactions within the slurry to enhance atomic separation of the lithium from the other node metals. Although the roasting may be performed at temperatures between 150 degrees C. and 350 degrees C. for a duration of no less than 9 hours and no more than 24 hours, more beneficial roasting may be achieved if performed at temperatures between 290 degrees C. and 310 degrees C. for a duration of no less than 11 hours and no more than 25 hours.

FIG. 8 is a modified block diagram 800 illustrating an exemplary system for roasting a black mass nitratenated slurry representative of the various implementations disclosed herein. As illustrated in FIG. 8, the system may comprise a roaster 820 for receiving the BMNS 810 as input and producing roasted black mass 830 as the output. Similar to other component described elsewhere herein, the roaster 830 may be automated to control both time and temperature plus any of several additional features that will be apparent to skilled artisans.

Accordingly, disclosed herein are various implementations directed to methods for producing lithium compounds and LF-metal-oxides from other node metals in black mass derived from broken lithium-ion batteries (LIBs), the method comprising: treating the black mass with nitric acid (HNO3) to dissolve lithium and the other node metals to form a solution; separating the graphite from the solution; and roasting the solution to form lithium compounds and multi-metal-oxides (MMOs) from the other node metals. Several such implementations may further comprise features whereby: the treating is performed at ambient temperatures without the application of external heat or pressure; the treating is performed for a period no less than four hours and no more than 24 hours; the roasting is performed at temperatures between 150 degrees C. and 350 degrees C. for a duration of no less than 9 hours and no more than 24 hours; and/or the roasting is performed at temperatures between 290degrees C. and 310 degrees C. for a duration of no less than 11 hours and no more than 2 5hours. Certain such implementations may also further comprise: removing the lithium compounds after the roasting; and/or recovering individual-metal-oxides (IMOs) from the MMOs after the removing, wherein the recovering may also comprise acid leaching of at least one metal oxide from among the IMOs.

Furthermore, various implementations disclosed herein also may be directed to systems for producing lithium compounds and LF-metal-oxides from other node metals in black mass derived from broken lithium-ion batteries (LIBs), the system comprising at least one subsystem capable of: treating the black mass with nitric acid (HNO3) to dissolve lithium and the other node metals to form a solution; separating the graphite from the solution; and roasting the solution to form lithium compounds and multi-metal-oxides (MMOs) from the other node metals. Several such implementations may further comprise features whereby: the treating is performed at ambient temperatures without the application of external heat or pressure; the treating is performed for a period of no less than four hours and no more than 24 hours; the roasting is performed at temperatures between 150 degrees C. and 350 degrees C. for a duration of no less than 9 hours and no more than 24 hours; the roasting is performed at temperatures between 290 degrees C. and 310 degrees C. for a duration of no less than 11 hours and no more than 25 hours; the at least one subsystem is further capable of removing the lithium compounds after the roasting; the at least one subsystem is further capable of recovering individual-metal-oxides (IMOs) from the MMOs after the removing; and/or the recovering comprises acid leaching of at least one metal oxide from among the IMOs.

In addition, various implementations disclosed herein may be directed to computer-readable media comprising computer-readable instructions for causing an automated apparatus to: treat black mass derived from broken lithium-ion batteries (LIBs) with nitric acid (HNO3) to form a solution comprising lithium and other node metals therein; separate insoluble graphite from the solution; and roast the solution to form lithium compounds and multi-metal-oxides (MMOs) from the other node metals. Certain such implementations may also further comprise computer-readable instructions whereby: the treating is performed at ambient temperatures without the application of external heat or pressure for a period no less than four hours and no more than 24 hours; the roasting is performed at temperatures between 150 degrees C. and 350 degrees C. for a duration of no less than 9 hours and no more than 24 hours; and/or the roasting is performed at temperatures between 290 degrees C. and 310 degrees C. for a duration of no less than 11 hours and no more than 25 hours.

### Regenerating NOX Gasses

During roasting, various nitrogen oxide gasses (NOX) are formed from the nitric acid (HNO3) component of the BMNS and might otherwise escape. As such, it is advantageous—if not also necessary and/or regulatorily required—to prevent the escape of NOX gasses. Moreover, the collection of NOX gasses can also be beneficial as NOX gasses resulting from roasting can be used to regenerate nitric acid (HNO3) with as much as 95% of the nitric acid (HNO3) used to produce the BMNS being regenerated. Accordingly, certain alternative implementations may comprise NOX regeneration.

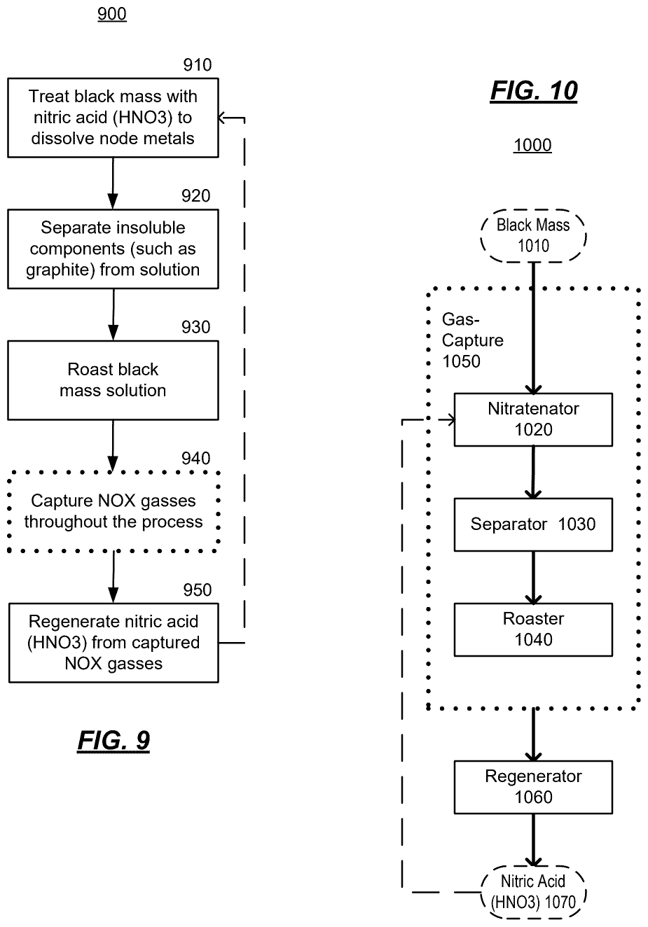

FIG. 9 is a process flow diagram 900 illustrating an exemplary approach for regenerating nitric acid (HNO3) from NOX created during roasting of black mass (such as BMNS) representative of the various implementations disclosed herein. In 9, at 910 black mass is treated with nitric acid (HNO3) to dissolve the node metals and form a solution (i.e., BMNS). At 920, insoluble components (e.g., graphite) are separated from the solution and, at 930, the black mass solution is then roasted. Throughout this process NOX gasses are emitted and, at 940, are captured (represented by the dotted-line box) so that, at 950, these captured NOX gasses may be regenerated back into nitric acid (HNO3). This regenerated nitric acid (HNO3) may then be reutilized in the treatment of subsequent black mass (indicated by the broken-line arrow).

FIG. 10 is a modified block diagram illustrating an exemplary system for regenerating nitric acid (HNO3) from NOX created during roasting of black mass (such as BMNS) representative of the various implementations disclosed herein. As illustrated in FIG. 10, the system may comprise a nitratenator 1020 for receiving the black mass 1010 and which is operably coupled to a separator 1030, which in turn is operably coupled to a roaster 1040. These various components may produce NOX gasses as a byproduct, and thus the various components are also operably coupled to (or closely integrated with, as shown in FIG. 10 as an encompassing dotted-line component) a gas-capture 1050 to which is conveyed the NOX gasses. The regenerator 1060 regenerates the received NOX gasses into nitric acid (HNO3) 1070 which may then optionally (indicated by the broken-line arrow) be returned for reuse by the nitratenator 1020.

Accordingly, disclosed herein are various implementations directed to methods for processing black mass derived from broken lithium-ion batteries (LIBs), the method comprising: treating the black mass with nitric acid (HNO3) to form a solution of dissolved node metals; roasting the solution to form lithium compounds and LF-metal-oxides from the node metals and gaseous nitrogen oxides (NOX) as a byproduct; and capturing and regenerating the gaseous NOX back into nitric acid (HNO3). Several such implementations may further comprise features whereby: the treating is performed at ambient temperatures without the application of external heat or pressure for a period of no less than four hours and no more than 24 hours; the roasting is performed at temperatures between 150 degrees C. and 350 degrees C. for a duration of no less than 9 hours and no more than 24 hours; the roasting is performed at temperatures between 290 degrees C. and 310 degrees C. for a duration of no less than 11 hours and no more than 25 hours; and/or the captured and regenerated nitric acid (HNO3) is used in a subsequent treatment of a subsequent black mass. Certain such implementations may also further comprise: physically separating insoluble graphite from the solution after the treating but before the roasting; removing the lithium compounds after the roasting; and/or recovering individual-metal-oxides (IMOs) from the MMOs after the removing.

Furthermore, various implementations disclosed herein also may be directed to systems for processing black mass derived from broken lithium-ion batteries (LIBs), the system comprising at least one subsystem capable of: treating the black mass with nitric acid (HNO3) to form a solution of dissolved node metals; roasting the solution to form lithium compounds and LF-metal-oxides from the node metals and gaseous nitrogen oxides (NOX) as a byproduct; and capturing and regenerating the gaseous NOX back into nitric acid (HNO3). Several such implementations may further comprise features whereby: the at least one subsystem is further capable of physically separating insoluble graphite from the solution after the treating but before the roasting; the treating is performed at ambient temperatures without the application of external heat or pressure for a period of no less than four hours and no more than 24 hours; the roasting is performed at temperatures between 150 degrees C. and 350 degrees C. for a duration of no less than 9 hours and no more than 24 hours; the roasting is performed at temperatures between 290 degrees C. and 310 degrees C. for a duration of no less than 11 hours and no more than 25 hours; the at least one subsystem is further capable of removing the lithium compounds after the roasting; the at least one subsystem is further capable of recovering individual-metal-oxides (IMOs) from the MMOs after the removing; and/or the captured and regenerated nitric acid (HNO3) is used in a subsequent treatment of a subsequent black mass.

In addition, various implementations disclosed herein may be directed to computer-readable media comprising computer-readable instructions for causing an automated apparatus to: treat black mass derived from broken lithium-ion batteries (LIBs) with nitric acid (HNO3) to form a solution of dissolved node metals; roast the solution to form lithium compounds and LF-metal-oxides from the node metals and gaseous nitrogen oxides (NOX) as a byproduct; and capture and regenerate the gaseous NOX back into nitric acid (HNO3). Certain such implementations may also further comprise computer-readable instructions whereby: the treating is performed at ambient temperatures without the application of external heat or pressure for a period of no less than four hours and no more than 24 hours; the roasting is performed at temperatures between 150 degrees C. and 350 degrees C. for a duration of no less than 9 hours and no more than 24 hours; and/or the roasting is performed at temperatures between 290 degrees C. and 310 degrees C. for a duration of no less than 11 hours and no more than 25 hours.

### Recovery via Lithium Carbonate

After the black mass is roasted, and the lithium therein is freed or unbound from the other node metals in the black mass—said black mass now comprising lithium compounds and multiple other metal-oxides in the form of a blend of said multi-metal-oxides (MMO)—the lithium is ready to be recovered before any of the individual metal-oxides (IMOs) are derived from the MMO (if at all).

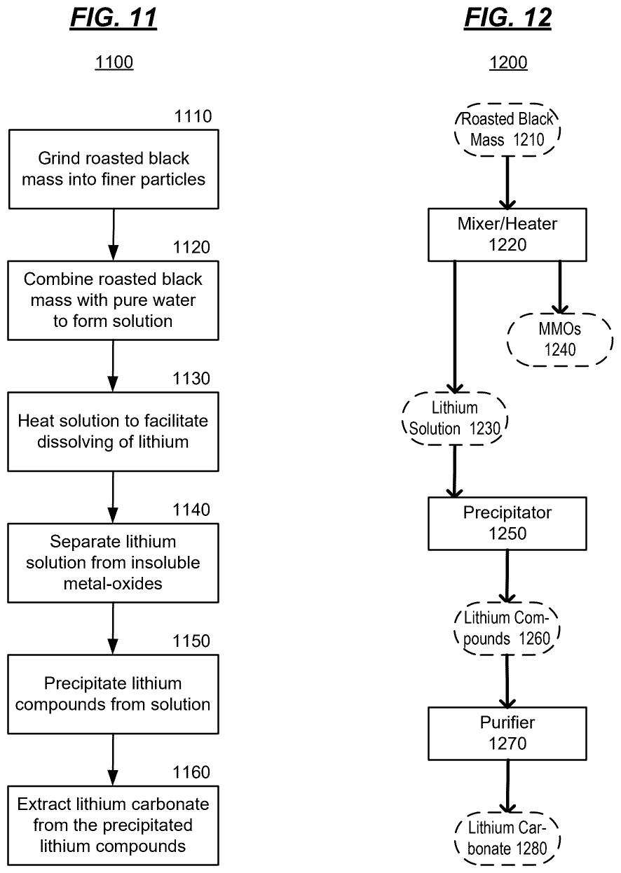

FIG. 11 is a process flow diagram 1100 illustrating an exemplary approach for the recovery of lithium from black mass before recovery of individual metal-oxides representative of the various implementations disclosed herein. In FIG. 11, at 1110 the roasted black mass is ground into finer particles and, at 1120, the finer particles of black mass are combined with pure water to form a lithium solution. At 1130 the lithium solution may be heated to facilitate the water dissolving the lithium compounds from the roasted black mass. At 1140 the dissolved lithium solution may be drawn off and/or the insoluble metal-oxides may be physically separated from the solution. At 1150 the lithium solution may then be treated with sodium carbonate (Na2CO3) to precipitate lithium compounds from the solution and, at 1160, the lithium compounds may be further treated using any of known means for specifically extracting lithium carbonate (Li2CO3) therefrom and/or with the remainder reconstituted as sodium carbonate (Na2CO3).

In this manner, recovery of the lithium from the black mass occurs before recovery of the other node metals from the black mass and, conversely, the recovery of the other node metals from the black mass occurs after recovery of the lithium or, alternatively, said metal-oxides may be maintained as a multi-metal-oxide (MMO) compound without further recovery of the individual metal-oxides therein (or subsequent recovery thereof substantially after the fact). For certain implementations the combination of black mass and water may be maintained at a temperature of between 70 degrees C. and 99 degrees C. for no less than two hours (or, alternatively, no less than thirty minutes) and no more than five hours, while for certain alternative implementations the combination of black mass and water may be maintained at a temperature of between 80 degrees C. and 90 degrees C. for no less than three hours (or, alternatively, no less than thirty minutes) and no more than four hours.

FIG. 12 is a modified block diagram 1200 illustrating an exemplary system for the recovery of lithium from black mass before recovery of individual metal-oxides representative of the various implementations disclosed herein. As illustrated in FIG. 12, the system comprises a mixer/heater 1220 for receiving the roasted black mass 1210 as input and then separating the lithium (as a solution) from the insoluble node metal-oxides in the form of an MMO, as thus the lithium (as a solution) is separated from the black mass before any individual metal-oxide is derived therefrom. The lithium solution 1230 may then be further processed by a precipitator 1250 to precipitate a resulting lithium compound 1260 from the solution which, in turn, may be further purified by the purifier 1270 to produce lithium carbonate 1280.

Accordingly, disclosed herein are various implementations directed to methods for recovering components from lithium-ion batteries (LIBs) comprising: recovering lithium from black mass produced from the LIBs before recovering one or more other node metals from the black mass; and recovering the one or more other node metals from the black mass of the LIBs after recovering the lithium. Several such implementations may further comprise features whereby: recovering lithium from black mass comprises combining the black mass with water to form a mixture comprising a lithium solution and one or more insoluble component, and physically separating the lithium solution from the one or more insoluble component for further treatment of the lithium solution to precipitate the lithium from the solution; the black mass is ground into fine particles before being combined with water, and wherein said water is pure water; the combination of black mass and water is maintained at a temperature of between 70 degrees C. and 99 degrees C. for no less than two hours (or, alternatively, no less than thirty minutes) and no more than five hours; the combination of black mass and water is maintained at a temperature of between 80 degrees C. and 90 degrees C. for no less than three hours (or, alternatively, no less than thirty minutes) and no more than four hours; the lithium solution is treated with sodium carbonate (Na2CO3) to precipitate the lithium from the solution as lithium carbonate (Li2CO3); the lithium solution is maintained at a temperature of between 80 degrees C. and 99 degrees C. when treated with the sodium carbonate (Na2CO3); the lithium solution is maintained at a temperature within three degrees of 90 degrees C. when treated with the sodium carbonate (Na2CO3); the precipitated lithium is physically separated from the solution; the precipitated lithium physically separated from the solution is in the form of lithium carbonate (Li2CO3); the one or more other node metals from the black mass comprises two or more node metals; the one or more other node metals from the black mass comprises at all other node metals present in the black mass; a first node metal from the one or more other node metals from the black mass is a metal oxide; the one or more other node metals from the black mass is a multi-metal-oxide comprising more than one node metal; and/or the recovered lithium is at least 90% of the total lithium originally present in the black mass.

Furthermore, various implementations disclosed herein also may be directed to systems comprising one or more subsystems capable of: recovering lithium from black mass produced from lithium-ion batteries (LIBs) before recovering one or more other node metals from the black mass; and recovering the one or more other node metals from the black mass of the LIBs after recovering the lithium. Several such implementations may further comprise features whereby: the one or more subsystems capable of recovering lithium from black mass is further capable of combining the black mass with water to form a mixture comprising a lithium solution and one or more insoluble component, and physically separating the lithium solution from the one or more insoluble component for further treatment of the lithium solution to precipitate the lithium from the solution; and/or the one or more subsystems capable of recovering lithium from black mass is further capable of treating the lithium solution with sodium carbonate (Na2CO3) to precipitate the lithium from the solution as lithium carbonate (Li2CO3).

In addition, various implementations disclosed herein may be directed to computer-readable media comprising computer-readable instructions for causing an automated apparatus to: recover lithium from black mass produced from lithium-ion batteries (LIBs) before recovering one or more other node metals from the black mass; and recover the one or more other node metals from the black mass of the LIBs after recovering the lithium. Certain such implementations may also further comprise computer-readable instructions whereby the computer-readable instructions for recovering lithium from black mass produced from the LIBs before recovering one or more other node metals from the black mass further comprise instructions for causing the automated apparatus to combine the black mass with water to form a mixture comprising a lithium solution and one or more insoluble component, physically separating the lithium solution from the one or more insoluble component for further treatment of the lithium solution to precipitate the lithium from the solution, and treating the lithium solution with sodium carbonate (Na2CO3) to precipitate the lithium from the solution as lithium carbonate (Li2CO3).

### “Lithium Trapping”

Although pure water can be used quite effectively to dissolve lithium in roasted black mass while leaving the other node metals in their insoluble oxide forms, these metal-oxides can trap as much as 40% of the resultant lithium solution as a residual impurity and thereby prevent a substantial amount of the lithium solution from being separated from said metal oxides through draining, straining, filtering, or other physical removal processes. However, additional processing of “wet” metal-oxides after the untrapped portion of the lithium solution is removed can also recover this otherwise-trapped lithium solution from the resultant “dry” metal-oxides. Specifically, after removing a first portion of the lithium from the black mass using water, a second portion of the lithium may be removed from the black mass utilizing an alcohol with the remainder comprising a relatively-pure multi-metal-oxides (MMO) as a byproduct.

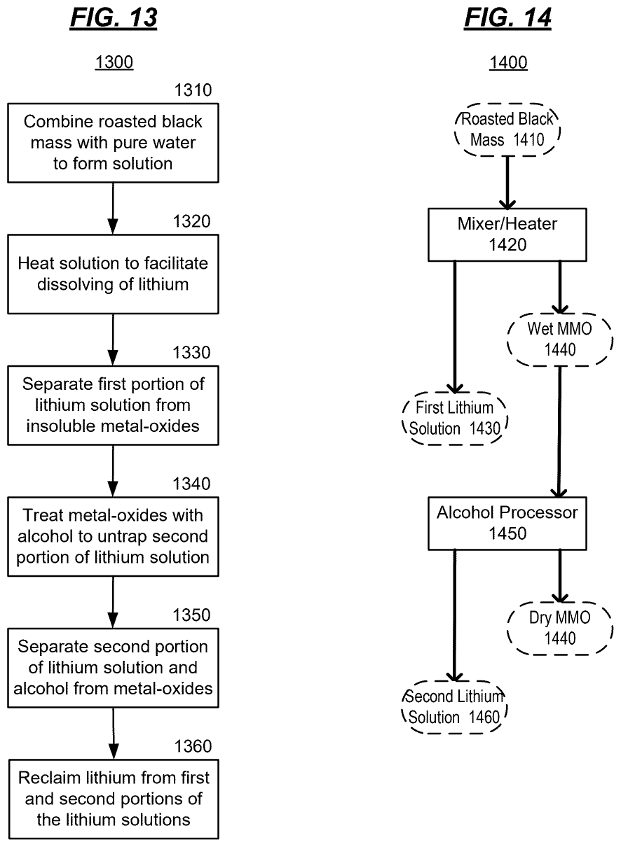

FIG. 13 is a process flow diagram 1300 illustrating an exemplary approach for the recovery of trapped lithium from “wet” black mass representative of various implementations disclosed herein. In FIG. 13, roasted black mass is combined with water (preferably pure water) to form a solution at 1310 which is then heated to facilitate dissolving of the lithium at 1320. At 1330, a first portion of the lithium solution (the “untrapped” portion) may then be separated (e.g., removed) from the mixture, leaving “wet” metal-oxides with a trapped second portion of the lithium solution adhering thereto. At 1340 this mixture is treated with alcohol to untrap the second portion of the lithium solution and, at 1350, this second portion of the lithium solution (and the alcohol) can be separated from the resultant “dry” metal-oxides that collectively constitute multi-metal-oxides (MMO). Additional water may also be added during this step to provide a medium into which the untrapped lithium may be dissolved or suspended for easier separation from the “dry” metal-oxides. Finally, at 1360, the lithium may be reclaimed from the first and second portions.

For various implementations the alcohol may comprise at least one monohydric alcohol such as ethanol (C2H5OH), and for certain such implementations the alcohol may comprise only ethanol (C2H5OH). For some implementations the alcohol used may comprise ethanol (C2H5OH) that is at least 90% pure, 95% pure, or even 99% pure depending on the desired efficiency for the process. For select implementations the water and/or the alcohol may also be recovered and/or reutilized.

FIG. 14 is a modified block diagram 1400 illustrating an exemplary system for the recovery of trapped lithium from “wet” black mass representative of various implementations disclosed herein. As illustrated in FIG. 14, a mixer/heater 1420 may receive the roasted black mass 1410 and produce a first lithium solution 1430 and wet MMO 1440. The mixer/heater 1420 is operably coupled to an alcohol processor 1450 for receiving the wet MMO 1440, adding alcohol to the MMO (and perhaps eventually some additional water) to free the trapped lithium from the MMO as a second lithium solution 1460 separable from the resultant dry MMO 1440.

Accordingly, disclosed herein are various implementations directed to methods for recovering components from black mass derived from broken lithium-ion batteries (LIBs), said black mass comprising graphite, lithium, and other node metals, the method comprising: extracting the graphite from the black mass; transforming the other node metals within the black mass into LF-metal-oxides; removing a first portion of the lithium from the black mass using water; and recovering a second portion of the lithium from the black mass utilizing an alcohol with the remainder comprising multi-metal-oxides (MMO) as a byproduct. Several such implementations may further comprise features whereby: the alcohol comprises at least one monohydric alcohol; the alcohol comprises ethanol (C2H5OH); the alcohol comprises only ethanol (C2H5OH); the alcohol comprises ethanol (C2H5OH) that is at least 90% pure; the alcohol comprises ethanol (C2H5OH) that is at least 95% pure; the alcohol comprises ethanol (C2H5OH) that is at least 99% pure; recovering the second portion of the lithium from the black mass comprises saturating the black mass with alcohol to facilitate physical separation of second portion of the lithium trapped by the MMOs, adding water to create a solution comprising the second portion of the lithium and the alcohol, separating the MMOs from the solution, and recovering the second portion of the lithium from the solution; recovering the first portion of the lithium from black mass comprises combining the black mass with water to form a mixture comprising a lithium solution and one or more insoluble components, and physically separating the first portion of the lithium solution from the one or more insoluble component for further treatment to precipitate the lithium from the solution; the black mass is ground into fine particles before being combined with water, and wherein said water is pure water; the combination of black mass and water is maintained at a temperature of between 70 degrees C. and 99 degrees C. for no less than two hours (or, alternatively, no less than thirty minutes) and no more than five hours; and/or the combination of black mass and water is maintained at a temperature of between 80 degrees C. and 90 degrees C. for no less than three hours (or, alternatively, no less than thirty minutes) and no more than four hours. Certain such implementations may also further comprise: recovering the alcohol utilized to remove the second portion of the lithium from the black mass; and/or recovering the water utilized to remove the first portion of the lithium from the black mass.

Furthermore, various implementations disclosed herein also may be directed to systems for recovering components from black mass derived from broken lithium-ion batteries (LIBs), said black mass comprising graphite, lithium, and other node metals, the system comprising one or more subsystems capable of: extracting the graphite from the black mass; transforming the other node metals within the black mass into LF-metal-oxides; removing a first portion of the lithium from the black mass using water; and recovering a second portion of the lithium from the black mass utilizing an alcohol with the remainder comprising multi-metal-oxides (MMO) as a byproduct. Several such implementations may further comprise features whereby: the one or more subsystems are further capable of saturating the black mass with alcohol to facilitate physical separation of the second portion of the lithium trapped by the MMO, adding water to create a solution comprising the second portion of the lithium and the alcohol, separating the MMO from the solution, and recovering the second portion of the lithium from the solution; and/or the alcohol utilized by the system is at least 90% ethanol.

In addition, various implementations disclosed herein may be directed to computer-readable media comprising computer-readable instructions for causing an automated apparatus to: extract the graphite from black mass derived from broken lithium-ion batteries (LIBs), said black mass comprising graphite, lithium, and other node metals; transforming the other node metals within the black mass into LF-metal-oxides; removing a first portion of the lithium from the black mass using water; and recovering a second portion of the lithium from the black mass utilizing ethanol (C2H5OH) with the remainder comprising multi-metal-oxides (MMO) as a byproduct. Certain such implementations may also further comprise computer-readable instructions to: saturate the black mass with alcohol to facilitate physical separation of the second portion of the lithium trapped by the MMO, add water to create a solution comprising the second portion of the lithium and the alcohol; separate the MMO from the solution, and recover the second portion of the lithium from the solution; and/or whereby the combination of black mass and water is maintained at a temperature of between 70 degrees C. and 99 degrees C. for no less than two hours (or, alternatively, no less than thirty minutes) and no more than five hours.

### Recovering Multi-Metal-Oxides (MMOs)

The by-product of lithium-first recovery is multi-metal-oxides (MMO) which may be sold or otherwise utilized as-is without any further recovery. However, the MMO can also be further processed to recover one or more individual metal oxides (and/or pure metals) from the other node metals comprising the MMO.

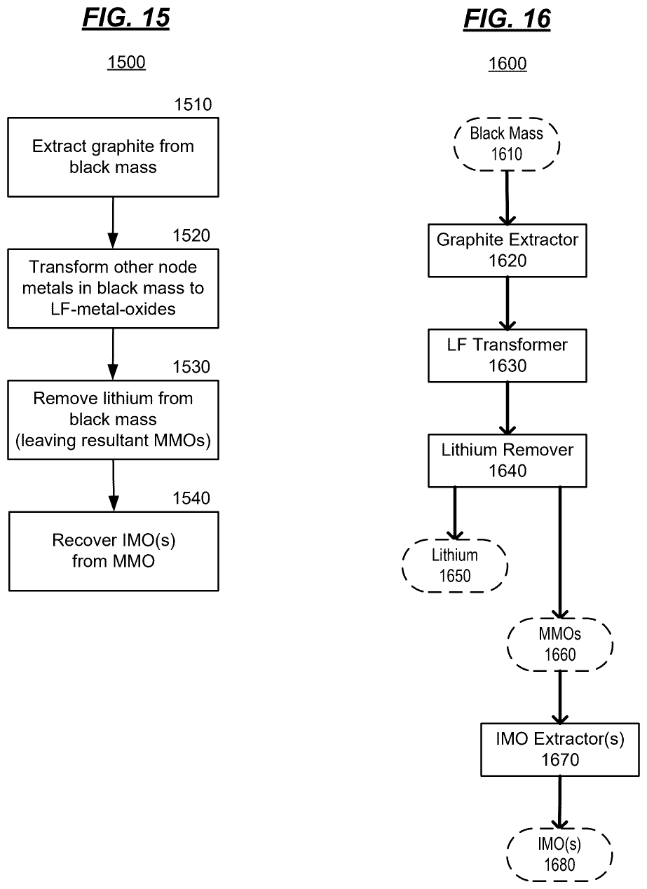

FIG. 15 is a process flow diagram 1500 illustrating an exemplary approach for the recovery individual metal-oxides (IMOs) after extraction of lithium from black mass in a manner representative of various implementations disclosed herein. In FIG. 15, at 1510 graphite is extracted from the black mass and, at 1520, the other node metals within the black mass are transformed into lithium-free-metal-oxides (LF-metal-oxides or LFMOs). At 1530 the lithium 1650 is then recovered from the black mass and the resultant MMOs 1660 that are left behind may then then further processed to recover the individual IMOs at 1540. Each IMO may be recovered from the MMO using acid leaching and/or acid leaching may also be used, directly or indirectly, to recover the elemental metal from each said metal oxide. This ambient leaching may be performed at ambient temperatures, that is, without application of external heating or pressure.

FIG. 16 is a modified block diagram 1600 illustrating an exemplary system for the recovery individual metal-oxides (IMOs) after extraction of lithium from black mass in a manner representative of various implementations disclosed herein. As illustrated in FIG. 16, the system may comprise a graphite extractor 1620 for receiving the black mass 1610 and removing the graphite therein. Operably coupled to the graphite extractor 1620 is a “lithium-free” (LF) transformer 1630 to transform the lithiated-metal-oxides within the black mass into LF-metal-oxides unbound to the resultant free lithium compounds. A lithium remover 1640 may then remove the lithium 1650 from the black mass and produce the resultant MMO 1660 which, when further processed by an IMO Extractor 1670 (or a plurality thereof) to produce individual-metal-oxide(s) 1680 (or even pure elemental metals) from the MMO 1660.

Accordingly, disclosed herein are various implementations directed to methods for recovering components from lithium-ion batteries (LIBs) comprising: removing graphite from black mass produced from the LIBs before recovering lithium and one or more other node metals present in the black mass; transforming the one or more other node metals present in the black mass into LF-metal-oxides; removing lithium from the black mass before recovering the one or more other node metals present in the black mass; and recovering the one or more other node metals. Several such implementations may further comprise features whereby: removing graphite from black mass produced from the LIBs before recovering lithium and one or more other node metals present in the black mass further comprises removing graphite from black mass produced from the LIBs before recovering lithium and all other node metals present in the black mass; transforming the one or more other node metals present in the black mass into LF-metal-oxides further comprises transforming two or more other node metals present in the black mass into LF-metal-oxides; transforming the two or more other node metals present in the black mass into LF-metal-oxides further comprises transforming all other node metals present in the black mass into LF-metal-oxides; wherein removing lithium from the black mass before recovering the one or more other node metals present in the black mass further comprises removing lithium from the black mass before recovering all of the other node metals present in the black mass; recovering the one or more other node metals further comprises recovering the one or more other node metals as an individual LF-metal-oxide (IMO) if comprising only one metal and as multi-metal-oxides (MMO) if comprising more than one metal; the acid leaching is performed at ambient conditions without application of external heat or pressure; removing lithium from the black mass further comprises combining the black mass with water to form a mixture comprising a lithium solution and the one or more other node metals as insoluble components of said mixture; the black mass is ground into fine particles before being combined with water, and wherein said water is pure water; the combination of black mass and water is maintained at a temperature of between 70 degrees C. and 99 degrees C. for no less than two hours (or, alternatively, no less than thirty minutes) and no more than five hours; the combination of black mass and water is maintained at a temperature of between 80 degrees C. and 90 degrees C. for no less than three hours (or, alternatively, no less than thirty minutes) and no more than four hours; removing lithium from the black mass before recovering the one or more other node metals present in the black mass further comprises combining the black mass with water to form a mixture comprising a lithium solution and the one or more other node metals as insoluble components of said mixture, and physically separating the lithium solution from the mixture; removing graphite from black mass produced from the LIBs before recovering lithium and one or more other node metals present in the black mass further comprises treating the black mass with nitric acid (HNO3) to dissolve the lithium and the one or more other node metals to form a solution from which the insoluble graphite is then physically removed; transforming the one or more other node metals present in the black mass into LF-metal-oxides further comprises treating the black mass with nitric acid (HNO3), and applying heat to the black mass for a period of time to form LF-metal-oxides; the applied heat is between 150 degrees C. and 350 degrees C. and the period of time is between 9 hours and 15 hours (or, alternatively, no more than 24 hours); and/or the applied heat is between 290 degrees C. and 310 degrees C. and the period of time is between 11 hours and 13 hours. Certain such implementations may also further comprise acid leaching the resultant IMO or MMO.

Furthermore, various implementations disclosed herein also may be directed to systems comprising one or more subsystems capable of: removing graphite from black mass produced from the LIBs before recovering lithium and one or more other node metals present in the black mass; transforming the one or more other node metals present in the black mass into LF-metal-oxides; removing lithium from the black mass before recovering the one or more other node metals present in the black mass; and recovering the one or more other node metals as an individual LF-metal-oxide (IMO) if comprising only one metal and as multi-metal-oxides (MMO) if comprising more than one metal. Several such implementations may further comprise features whereby transforming the one or more other node metals present in the black mass into LF-metal-oxides further comprises treating the black mass with nitric acid (HNO3), and applying heat to the black mass to facilitate formation of LF-metal-oxides for each of the one or more other node metals present in the black mass.

In addition, various implementations disclosed herein may be directed to computer-readable media comprising computer-readable instructions for causing an automated apparatus to: remove graphite from black mass produced from the LIBs before recovering lithium and one or more other node metals present in the black mass; transform the one or more other node metals present in the black mass into LF-metal-oxides; remove lithium from the black mass before recovering the one or more other node metals present in the black mass; and recover the one or more other node metals as an individual LF-metal-oxide (IMO) if comprising only one metal and as multi-metal-oxides (MMO) if comprising more than one metal.

### Water Recovery

Throughout several portions of the “lithium-first” implementations described earlier herein, water (e.g., pure water) has been an important component in the recovery of lithium from black mass. For several of such implementations, an added feature may be the recovery of the water utilized and/or reuse of that water for subsequent processing of new black mass. Any of several known techniques for the recovery of water—such as by any evaporative process—are fully anticipated for use in conjunction with the various implementations disclosed herein, including closed-loop implementations where effectively all of the water used is reclaimed and/or reutilized.

Accordingly, disclosed herein are various implementations directed to methods for processing black mass derived from broken lithium-ion batteries (LIBs), the black mass comprising graphite, lithium, and other node metals, the method comprising: extracting the graphite from the black mass; transforming the other node metals within the black mass into multi-metal-oxides (MMO); removing the lithium from the black mass by combining the black mass with water to form a mixture comprising a lithium solution and the other node metals as insoluble components of said mixture, and separating the lithium solution from the other node metals in the mixture; and recovering the water from the lithium solution. Several such implementations may further comprise features whereby: recovering the water from the lithium solution further comprises treating the lithium solution with sodium carbonate (Na2CO3) to cause precipitation of lithium carbonate (Li2CO3) and formation of a sodium solution—such as, for example, sodium hydroxide (NaOH)—and separating the water from the sodium solution; the separating comprises evaporating the water in the solution, relocating the evaporated water, and condensing the evaporated water; the black mass is ground into fine particles before being combined with water; the water is pure water; the combination of black mass and water is maintained at a temperature of between 70 degrees C. and 99 degrees C. for no less than two hours (or, alternatively, no less than thirty minutes) and no more than five hours; and/or the combination of black mass and water is maintained at a temperature of between 80 degrees C. and 90 degrees C. for no less than three hours (or, alternatively, no less than thirty minutes) and no more than four hours.

Furthermore, various implementations disclosed herein also may be directed to systems for processing black mass derived from broken lithium-ion batteries (LIBs), the black mass comprising graphite, lithium, and other node metals, the system comprising at least one subsystem capable of: extracting the graphite from the black mass; transforming the other node metals within the black mass into multi-metal-oxides (MMO); and/or removing the lithium from the black mass by combining the black mass with water to form a mixture comprising a lithium solution and the other node metals as insoluble components of said mixture, and separating the lithium solution from the other node metals in the mixture; and recovering the water from the lithium solution. Several such implementations may further comprise features whereby: recovering the water from the lithium solution further comprises treating the lithium solution with sodium carbonate (Na2CO3) to cause precipitation of lithium carbonate (Li2CO3) and formation of a sodium solution—such as, for example, sodium hydroxide (NaOH)—and separating the water from the sodium hydroxide (NaOH); the separating comprises evaporating the water in the solution, conveying the evaporated water away from the solution, and condensing the evaporated water; the black mass is ground into fine particles before being combined with water; the water is pure water; the combination of black mass and water is maintained at a temperature of between 70 degrees C. and 99 degrees C. for no less than two hours (or, alternatively, no less than thirty minutes) and no more than five hours; and/or the combination of black mass and water is maintained at a temperature of between 80 degrees C. and 90 degrees C. for no less than three hours (or, alternatively, no less than thirty minutes) and no more than four hours.

In addition, various implementations disclosed herein may be directed to computer-readable media comprising computer-readable instructions for causing an automated apparatus to: extract the graphite from black mass derived from broken lithium-ion batteries (LIBs), the black mass comprising graphite, lithium, and other node metals; transform the other node metals within the black mass into multi-metal-oxides (MMO); remove the lithium from the black mass by combining the black mass with water to form a mixture comprising a lithium solution and the other node metals as insoluble components of said mixture, and separating the lithium solution from the other node metals in the mixture; and recover the water from the lithium solution. Certain such implementations may also further comprise computer-readable instructions whereby recovering the water from the lithium solution further comprises treating the lithium solution with sodium carbonate (Na2CO3) to cause precipitation of lithium carbonate (Li2CO3) and formation of a sodium solution—such as, for example, sodium hydroxide (NaOH)—and separating the water from the sodium hydroxide (NaOH); evaporating the water in the solution, relocating the evaporated water, and condensing the evaporated water; the black mass is ground into fine particles before being combined with water, and wherein the water is pure water; the combination of black mass and water is maintained at a temperature of between 70 degrees C. and 99 degrees C. for no less than two hours (or, alternatively, no less than thirty minutes) and no more than five hours; and/or the combination of black mass and water is maintained at a temperature of between 80 degrees C. and 90 degrees C. for no less than three hours (or, alternatively, no less than thirty minutes) and no more than four hours.

### Example Computing Environment

Various implementations disclosed herein may also be augmented,

automated, or more efficiently and effectively operated in conjunction with computing systems and software specifically developed for these purposes.

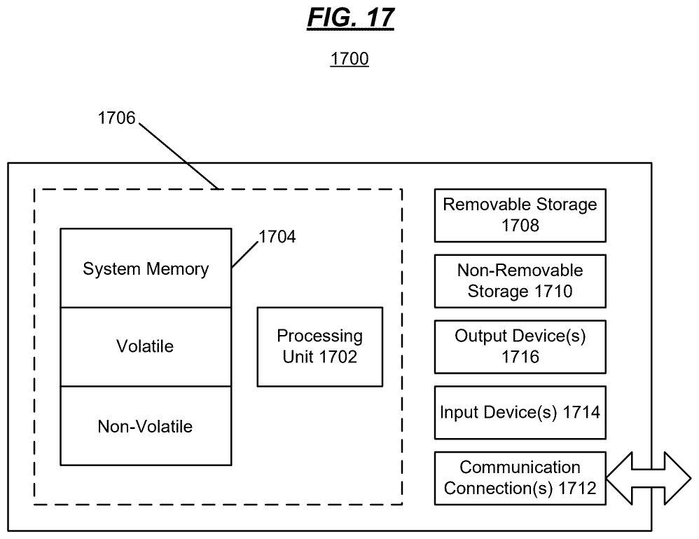

FIG. 17 is a block diagram of an example computing environment that may be used in conjunction with example implementations and aspects such as those disclosed and described with regard to the other figures presented herein and herewith. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA), an analog-to-digital converter (ADC), or other programmable logic device, discrete gate or transistor logic, discrete hardware components, discrete data acquisition components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

With reference to FIG. 17, an example system for implementing aspects described herein includes a computing device, such as computing device 1700. In a basic configuration, computing device 1700 typically includes at least one processing unit 1702 and memory 1704. Depending on the exact configuration and type of computing device, memory 1704 may be volatile (such as random access memory (RAM)), non-volatile (such as read-only memory (ROM), flash memory, etc.), or some combination of the two. This basic configuration is illustrated in FIG. 17 by dashed line 1706 and may be referred to collectively as the “compute” component.

Computing device 1700 may have additional features/functionality. For example, computing device 1700 may include additional storage (removable and/or non-removable) including, but not limited to, magnetic or optical disks or tape. Such additional storage is illustrated in FIG. 17 by removable storage 1708 and non-removable storage 1710. Computing device 1700 typically includes a variety of computer readable media. Computer readable media can be any available media that can be accessed by device 1700 and may include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 1704, removable storage 1708, and non-removable storage 1710 are all examples of computer storage media. Computer storage media include, but are not limited to, RAM, ROM, electrically erasable program read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store the information and which can be accessed by computing device 1700. Any such computer storage media may be part of computing device 1700.

Computing device 1700 may contain communication connection(s) 1712 that allow the device to communicate with other devices. Computing device 1700 may also have input device(s) 1714 such as a keyboard, mouse, pen, voice input device, touch input device, and so forth. Output device(s) 1716 such as a display, speakers, printer, and so forth may also be included. All these devices are well-known in the art and need not be discussed at length herein. Computing device 1700 may be one of a plurality of computing devices 1700 inter-connected by a network. As may be appreciated, the network may be any appropriate network, each computing device 1700 may be connected thereto by way of communication connection(s) 1712 in any appropriate manner, and each computing device 1700 may communicate with one or more of the other computing devices 1700 in the network in any appropriate manner. For example, the network may be a wired or wireless network within an organization or home or the like, and may include a direct or indirect coupling to an external network such as the Internet or the like. Moreover, PCI, PCIe, and other bus protocols might be utilized for embedding the various implementations described herein into other computing systems.

### Interpretation of Disclosures Herein

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an API, reusable controls, or the like. Such programs may be implemented in a high-level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. In one example, the controller service may be accessed by a mobile device. In another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

### Anticipated Alternatives

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims. For particular implementations described with reference to block diagrams and/or operational illustrations of methods, it should be understood that each block of the block diagrams and/or operational illustrations, and combinations of blocks in the block diagrams and/or operational illustrations, may be implemented by analog and/or digital hardware, and/or computer program instructions. Computer program instructions for use with or by the implementations disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system. The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device. Volatile media may include dynamic memory, such as main memory. Transmission media may include coaxial cables, copper wire, and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

In the foregoing description, for purposes of explanation and non-limitation, specific details are set forth-such as particular nodes, functional entities, techniques, protocols, standards, etc.-in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims presented below.

### Copyright Notice

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A method for recovering components from lithium-ion batteries (LIBs) comprising:
removing graphite from black mass produced from the LIBs before recovering lithium and one or more other node metals present in the black mass;
transforming the one or more other node metals present in the black mass into LF-metal-oxides;
removing lithium from the black mass before recovering the one or more other node metals present in the black mass; and
recovering the one or more other node metals.

2. The method of claim 1, wherein removing graphite from black mass produced from the LIBs before recovering lithium and one or more other node metals present in the black mass further comprises removing graphite from black mass produced from the LIBs before recovering lithium and all other node metals present in the black mass.

3. The method of claim 1, wherein transforming the one or more other node metals present in the black mass into LF-metal-oxides further comprises transforming two or more other node metals present in the black mass into LF-metal-oxides.

4. The method of claim 3, wherein transforming the two or more other node metals present in the black mass into LF-metal-oxides further comprises transforming all other node metals present in the black mass into LF-metal-oxides.

5. The method of claim 1, wherein removing lithium from the black mass before recovering the one or more other node metals present in the black mass further comprises removing lithium from the black mass before recovering all of the other node metals present in the black mass.

6. The method of claim 1, wherein recovering the one or more other node metals further comprises recovering the one or more other node metals as an individual LF-metal-oxide (IMO) if comprising only one metal and as multi-metal-oxides (MMO) if comprising more than one metal.

7. The method of claim 6, further comprising acid leaching the resultant IMO or MMO.

8. The method of claim 7, wherein the acid leaching is performed at ambient conditions without application of external heat or pressure.

9. The method of claim 1, wherein removing lithium from the black mass further comprises combining the black mass with water to form a mixture comprising a lithium solution and the one or more other node metals as insoluble components of said mixture.

10. The method of claim 9, wherein the black mass is ground into fine particles before being combined with water, and wherein said water is pure water.

11. The method of claim 9, wherein the combination of black mass and water is maintained at a temperature of between 70 degrees C. and 99 degrees C. for no less than two hours and no more than five hours.

12. The method of claim 9, wherein the combination of black mass and water is maintained at a temperature of between 80 degrees C. and 90 degrees C. for no less than three hours and no more than four hours.

13. The method of claim 1, wherein removing lithium from the black mass before recovering the one or more other node metals present in the black mass further comprises:
combining the black mass with water to form a mixture comprising a lithium solution and the one or more other node metals as insoluble components of said mixture; and
physically separating the lithium solution from the mixture.

14. The method of claim 1, wherein removing graphite from black mass produced from the LIBs before recovering lithium and one or more other node metals present in the black mass further comprises treating the black mass with nitric acid (HNO3) to dissolve the lithium and the one or more other node metals to form a solution from which the insoluble graphite is then physically removed.

15. The method of claim 1, wherein transforming the one or more other node metals present in the black mass into LF-metal-oxides further comprises:
treating the black mass with nitric acid (HNO3); and
applying heat to the black mass for a period of time to form LF-metal-oxides.

16. The method of claim 15, wherein the applied heat is between 150 degrees C. and 350 degrees C. and the period of time is between 9 hours and 15 hours.

17. The method of claim 15, wherein the applied heat is between 290 degrees C. and 310 degrees C. and the period of time is between 11 hours and 13 hours.

18. A system comprising one or more subsystems capable of:
removing graphite from black mass produced from the LIBs before recovering lithium and one or more other node metals present in the black mass;
transforming the one or more other node metals present in the black mass into LF-metal-oxides;
removing lithium from the black mass before recovering the one or more other node metals present in the black mass; and
recovering the one or more other node metals as an individual LF-metal-oxide (IMO) if comprising only one metal and as multi-metal-oxides (MMO) if comprising more than one metal.

19. The system of claim 18, wherein transforming the one or more other node metals present in the black mass into LF-metal-oxides further comprises:
treating the black mass with nitric acid (HNO3); and
applying heat to the black mass to facilitate formation of LF-metal-oxides for each of the one or more other node metals present in the black mass.

20. A non-transitory computer-readable medium comprising computer-readable instructions for causing an automated apparatus to:
remove graphite from black mass produced from the LIBs before recovering lithium and one or more other node metals present in the black mass;
transform the one or more other node metals present in the black mass into LF-metal-oxides;
remove lithium from the black mass before recovering the one or more other node metals present in the black mass; and
recover the one or more other node metals as an individual LF-metal-oxide (IMO) if comprising only one metal and as multi-metal-oxides (MMO) if comprising more than one metal.
